(19) United States
(12) Patent Application Publication
(10) Pub. No.: US 2010/0192478 A1
(43) Pub. Date: Aug. 5, 2010

(54) STONE-COATED GUTTER COMPONENTS AND STONE COATING FOR GUTTER COMPONENTS

(76) Inventor: James W. Horton, Yulee, FL (US)

Correspondence Address: Jennifer Meredith;Lippes Mathias Wexler Friedman LLP, 665 Main Street, Suite 300, Buffalo, NY, 14203, US

(21) Appl. No.: 12/538,152

(22) Filed: Aug. 9, 2009

Related U.S. Application Data
(60) Provisional application No. 61/091,756, filed on Aug. 26, 2008.

(51) Int. Cl. E04D 13/064; B05D 1/36; B05C 11/00

(52) U.S. Cl. 52/11; 427/203; 427/202; 118/696

(57) ABSTRACT

Stone-coated gutter component and method, device and system for controlling size of color patches and shade of highlights during stone coating of gutter products such as gutter covers. Several sets of grooved rollers are used to guide stone granules from hoppers onto a gutter component that has been sprayed with basecoat. The gutter component is generally metal. Start and stop and speed of rotation of the grooved rollers are controlled by servomotors that are in turn controlled by one or more programmable logic controllers. Size of color patches is controlled by controlling the start and stop of the rollers. Shading and highlight are controlled by controlling the speed of rotation of the rollers. Changing the angle of divider planes that are used on hoppers creates heavier or lighter bands of stone coating. A chip booth applies base or background between color patches. The stone-coated gutter component is glazed and cured in an oven.

### CROSS-REFERENCE TO RELATED APPLICATIONS

The present application claims priority to and the benefit of the U.S. Provisional Patent Application No. 61/091,756, filed in the United States Patent and Trademark Office on Aug. 26, 2008, the entire content of which is incorporated by this reference.

### BACKGROUND OF THE INVENTION

1. Field of the Invention

The present invention pertains generally to the field of coating roofing components and, more particularly, to coating of gutter components.

2. Description of Related Art

Metal roofing has recently become popular in the roofing industry. Metal, however, does not provide the same aesthetic effect as natural material such as wood shakes and shingle or slate do. In order to combine the strength and the durability of steel with the appearance of more natural products, metal panels can be coated with granules to produce stone-coated steel. Hence, coating of metal roofing material is carried out.

Coated steel roofs can be made in different colors and styles that simulate the look of tile, wood, and composition shingles. Such metal roofing material are usually quite durable, lightweight, non combustible and not susceptible to cracking, breaking, burning, curling, splitting or rotting. They are non-porous and resistant to freezing and thawing. They are walkable and require a low degree of maintenance. Interlocking panels of such roofing material may be constructed that provide weather tight barriers.

### BRIEF SUMMARY OF THE INVENTION

The natural look of the coated steel roofs is, however, interrupted when the roof reaches the gutter or the gutter cover. Gutters and their associated components are generally made from aluminum, or some other metal or combination of metals. Gutter components include gutter panels and gutter protection products such as gutter covers. Gutter components have not been available as coated components.

Aspects of the present invention provide stone-coated gutter components such as stone-coated metal gutter protection products that may be made to match other roofing material such as the shingles. Aspects of the present invention further provide methods, devices and systems for stone coating of gutter components.

Stone coating of the gutter components, including gutter covers, provides advantages additional to improved aesthetics of the component or product. For example, stone coating makes the gutter component or product hydrophilic and, therefore, slows down the flow of the rain guiding it into the gutter.

Yet, despite the above advantages, stone-coated gutter components and products have not been available to date.

One aspect of the present invention provides a stone-coated gutter component. The stone-coated gutter component includes a gutter component, a basecoat covering the gutter component, and stone granules adhering to the gutter component and coating the gutter component to yield the stone-coated gutter component. The basecoat causes the stone granules to adhere to the gutter component. The gutter component is a gutter cover made from metal.

One aspect of the present invention provides a method for stone coating gutter components. The method includes applying a basecoat to a gutter component, applying stone granules to the gutter component after having applied the basecoat where the stone granules are applied by rollers receiving the stone granules from hoppers and the stone granules are applied in patches or bands, controlling a size of the patches or bands by controlling a start and stop of the rollers, and controlling a shading and an intensity of color of the patches or bands by controlling a speed of the rollers. The rollers are controlled by a programmable logic controller. The gutter components are made of metal, and the gutter components include gutter covers.

One aspect of the present invention provides a device for stone coating gutter components. The device includes sets of rollers for applying stone granules to a gutter component to obtain stone-coated gutter components, one or more motors for controlling rollers in the sets of rollers, one or more programmable logic controllers for controlling the motors, a chip booth for applying a mixed blend of stone chips to the stone-coated gutter component to create background color, and a fan for blowing off excess of the stone chips from the stone-coated gutter component. The motors control a shading of color on the stone-coated gutter component by controlling a speed of rotation of the rollers. The motors control a size and location of color patches on the stone-coated gutter component by controlling a start and stop of the rotation of the rollers, and the programmable logic controller is programmed to control the motors.

One aspect of the present invention provides a system for stone coating gutter components. The system includes a coating conveyor for conveying a gutter component through the system, a basecoat spray booth for applying a basecoat to the gutter component to obtain a sprayed gutter component, a color-patching booth for applying stone chips to the sprayed gutter component to obtain a color-patched gutter component, a glaze spray booth for applying a sealant to the color-patched gutter component to obtain a sealed gutter component, an oven for curing the sealed gutter component to obtain a stain-coated gutter component, and hoppers for feeding the stone chips to the color-patching booth. The color-patching booth includes sets of rollers being controlled by servomotors. A start and stop and a speed of rotation of rollers in the sets of rollers is controlled by the servomotors through a programmable logic controller. The start and stop of the rollers determines a size of color patches generated by the color-patching booth, and the speed of rotation of rollers determines a shadowing of highlights generated by the color-patching booth. Divider planes impact an amount of stone chips fed by the hoppers.

### BRIEF DESCRIPTION OF THE DRAWINGS

FIG. 1A shows a schematic diagram of stone-coated gutter components, according to the aspects of the present invention.

FIG. 1B shows a photograph of a stone-coated gutter cover, according to the aspects of the present invention.

FIG. 1C shows another photograph of a stone-coated gutter cover, according to the aspects of the present invention.

FIG. 2 is a schematic drawing of an overall stone coating application system, according to the aspects of the present invention.

FIG. 3 shows a flowchart of a method of stone coating for gutter components, according to the aspects of the present invention.

FIG. 4 is a schematic drawing of one exemplary basecoat spray booth for use with the system of FIG. 2, according to the aspects of the present invention.

FIG. 5 is a schematic drawing of one exemplary color-patching booth, according to the aspects of the present invention.

FIG. 6 shows a flowchart of a method of applying color patches and bands at a color-patching booth, according to the aspects of the present invention.

FIG. 7 is a schematic drawing showing the interaction of hoppers with rollers, dividers and the coating conveyor, according to the aspects of the present invention.

### DETAILED DESCRIPTION OF THE INVENTION

Certain metal gutter components such as a gutter itself, the gutter cover or the gutter protection panel as well as metal ventilation components such as roof vent or roof vent accessories are usually coated for their finishing step. Aspects of the present invention provide stone-coated metal components used for gutter products or roof vent products. Methods of obtaining a stone-coated metal gutter or vent product and devices and systems for stone coating of metal gutter products are also provided as aspects of the present invention.

During an exemplary coating process, according to the aspects of the present invention, the components are loaded onto a coating conveyor and are carried through a coating application process by pushers fitted to the conveyor chain. The coating conveyor transports the component through a basecoat spray booth. The loading of the components onto the coating conveyor and the transport of the components through the basecoat spray booth may be performed automatically.

Gutters and gutter components are often made from aluminum. Other types of metal such as copper, steal or zinc may also be used for manufacture of gutters and gutter components. Vents and ventilation products are also generally made from metals.

Basecoat is sprayed onto the bare metal component in the basecoat spray booth. In one aspect of the present invention, the spray booth features two spray guns. The spray guns operate in an on/off fashion such that they stop spraying if no component is present on the conveyor belt in the line. In one aspect of the present invention, the spray booth includes a scrubber unit. The scrubber unit keeps a negative pressure in the booth to extract any over spray. In one aspect of the present invention the basecoat is sprayed onto the component to a thickness of about 12 mils which is approximately equal to 305 micrometers. In one aspect of the present invention, acrylic water-based glue is used as the basecoat.

After passing through the basecoat spray booth, the components pass through a color-patching booth. In the color-patching booth, the stone chips are dropped onto the components, while the components are still wet with basecoat. The components may be metal panels or other types of metal components.

The color-patching booth places shadow strips and chip patches on the components. The shadow strips highlight the components and the chip patches provide design. The color-patching booth includes a patch unit. In one aspect of the present invention, the patch unit contains three sets of rollers, the first set for creating the shadows and highlights and the other two sets for creating the color patches. The first set that is for creating the shadows includes a pair of rollers. The other two sets also each include a pair of rollers. In various other aspects of the present invention, a different number of rollers may be used. The patching unit may be divided into a shadow and highlight system that is located before a granule patching system. In the particular aspect of the present invention that is mentioned above, the shadow and highlight system includes the first set of rollers that includes one pair of rollers and the granule patching system includes the second and third sets of rollers that each also include a pair of rollers.

In one aspect of the present invention, the color-patching booth includes three sets of servomotors, controlled by a Programmable Logic Controller (PLC), driving the three sets of grooved rollers. Each set of grooved rollers includes a pair of grooved rollers. First, each pair of rollers carries the premixed stone granules from two different hoppers. Next, the paired rollers meter and blend two contrasting mixes of stone granules. Finally, each pair of rollers applies the premixed stone granules in patches to the components. For example, when the components are metal panels, each pair of rollers drops the premixed stone granules as color patches onto the panels. This operation may be performed in a substantially precise manner.

The use of a PLC to control the servomotors that drive the grooved rollers allows not only substantially precise patch size, but also different shading or shadowing of the mixes of stone. The patch size is controlled by starting and stopping the servomotors at predetermined times as the panel travels under the roller. Shading or shadowing of the mixes of stone is controlled through controlling the speed of rotation of the servomotors.

In one aspect of the present invention, providing shadow and highlight is performed by two or three PLC controlled servomotor-driven grooved rollers that apply narrow bands of stone granules to the component. For example, when the component is a metal panel that includes steps, the narrow bands of stone granules are applied at the rear and front of each step in the metal panel. In one aspect of the present invention, the shadow and highlight system is located immediately before the granule patching system described above and it works in tandem with the granule patching system to discharge granules on the panel locations with or without the contrasting color patches. In one aspect of the present invention, two hops feed granules through the two or three grooved rollers of the shadow and highlight system. Fewer or more hops may be used to provide more colors. Also, fewer or more rollers may be used in each system.

The quantity of granules delivered, and therefore the intensity of the color, can be controlled by varying the speed of rotation of the servomotors. The width of the bands of color can be adjusted by moving divider plates in the delivery hoppers above the grooved rollers. The divider plates can be set at an angle to achieve a flared shadow effect with one edge of the shadow band being heavier (containing more granules) than the other edge.

The color-patching booth also includes a chip booth. The chip booth coats the metal component evenly with its base, or background color. In the chip booth all the gaps between the patches, shadows and highlights already on the panel are filled with a mixed blend of stone granules and then all excess loose granules are removed. In one aspect of the present invention, the chips are dropped via two drops of chips with blow on nozzle to help chip coverage. The excessive amount of stone chip is blown off by air.

As a result of the process of application of the stone chips, the surface of the component turns into a “stone-coated” surface having differing colors and shades in different areas. The color of particular areas is determined by the ratio of differently colored stone granules, to create a variety of colors and shades. In one aspect of the present invention, four mixes of granules are used: one very light, one dark and two in between.

The color and shades are coordinated with the raised and lower patches so that, in certain parts of the component, the appearance of depth is enhanced by creating shadows with darker colors. In one exemplary aspect of the present invention, granules of a dark color are delivered adjacent and immediately below the risers so as to give the impression of a shadow caused by the riser. The “fake” shadow gives the impression that the riser is higher than it really is. This has an ornamental advantage of being attractive without weakening the panel or using additional metal in its manufacture.

In one exemplary aspect, the stone granules used in this process are grade 14 ceramic coated stone granules supplied by the Minnesota Mining and Manufacturing Company of Saint Paul, Minn. Other sizes of the stone granules can be used as well. Other grades may be used by first adjusting the viscosity of the basecoat.

The method of the application of the stones, as set forth by the above description, permits substantially precise placement of patches of different color mixes of stone granules on the metal panel or another component that is being subjected to stone coating.

The basecoat has a degree of thickness and viscosity that causes the stone granules stick to the panels in the positions in which they are dropped onto the panels by the patching shadowing, highlighting and granule applicator systems.

Finally, the component passes through a glaze spray booth. The glaze spray booth coats the component with a glaze layer, or a sealant layer. In one exemplary aspect, a water-based acrylic adhesive is used as a glaze or a sealant, to achieve a wet thickness of about 1 mil which is about 25 micrometers. In one exemplary aspect, the glaze spray booth features two on/off spray guns to stop the spray if no component is present in the line. The glaze spray booth includes a scrubber unit. The scrubber unit keeps a negative pressure in the booth to extract any over-spray.

Fully coated components or panels are then transferred into an oven where the basecoat and glaze are cured at an exemplary initial temperature of about 60 degrees C. This temperature may be gradually raised up to about 100 degree C. The curing time may be within a range of between about 65 minutes to about 75 minutes. In one exemplary aspect of the present invention, the curing time is about 70 minutes.

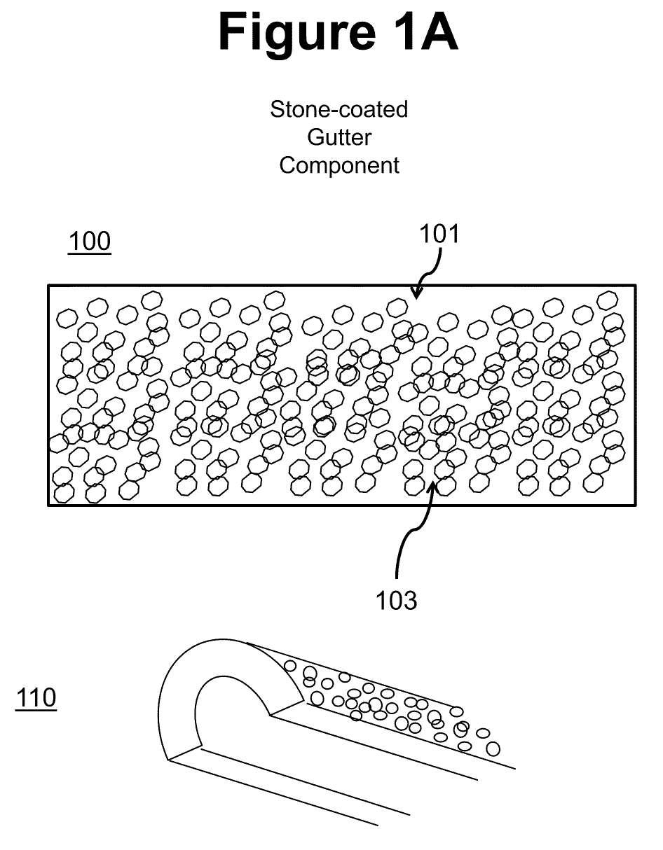

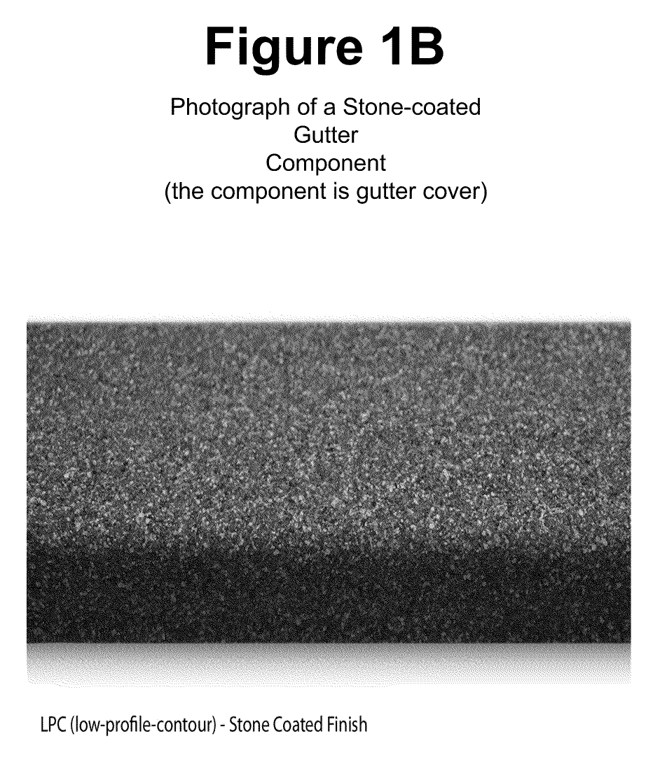

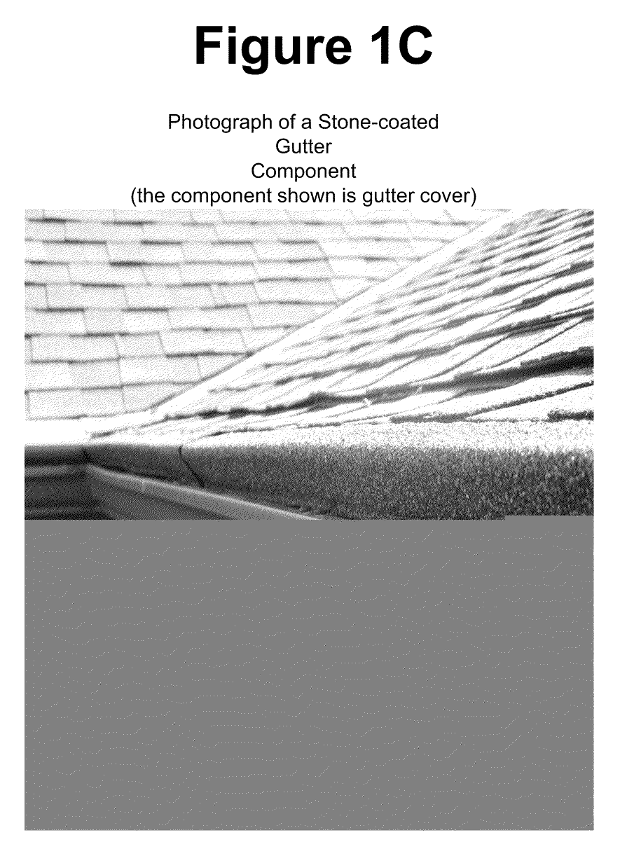

FIG. 1A shows a schematic diagram of stone-coated gutter components, according to the aspects of the present invention.

A stone-coated gutter component 100 is shown in this drawing. A gutter component 101 is coated with stone granules 103 to form the stone-coated gutter component 100. The gutter component 100 is exemplarily shown as one panel of a gutter cover. The gutter component 101 is made from some type of metal such as aluminum, copper, steel, zinc or another appropriate metal. Although non-metallic material may also be used.

Another stone-coated gutter component 110 is also shown. The component 110 is exemplarily shown as a round gutter with the outer surface coated with stone-coating to match the natural-looking material of the roof and the building.

FIG. 1B shows a photograph of a stone-coated gutter cover, according to the aspects of the present invention.

A photograph of one exemplary stone-coated gutter component is shown in FIG. 1B. The gutter component shown in FIG. 1B is a gutter cover.

FIG. 1C shows another photograph of a stone-coated gutter cover, according to the aspects of the present invention.

A photograph of another exemplary stone-coated gutter component is shown in FIG. 1C. The gutter component shown in FIG. 1C is also a gutter cover.

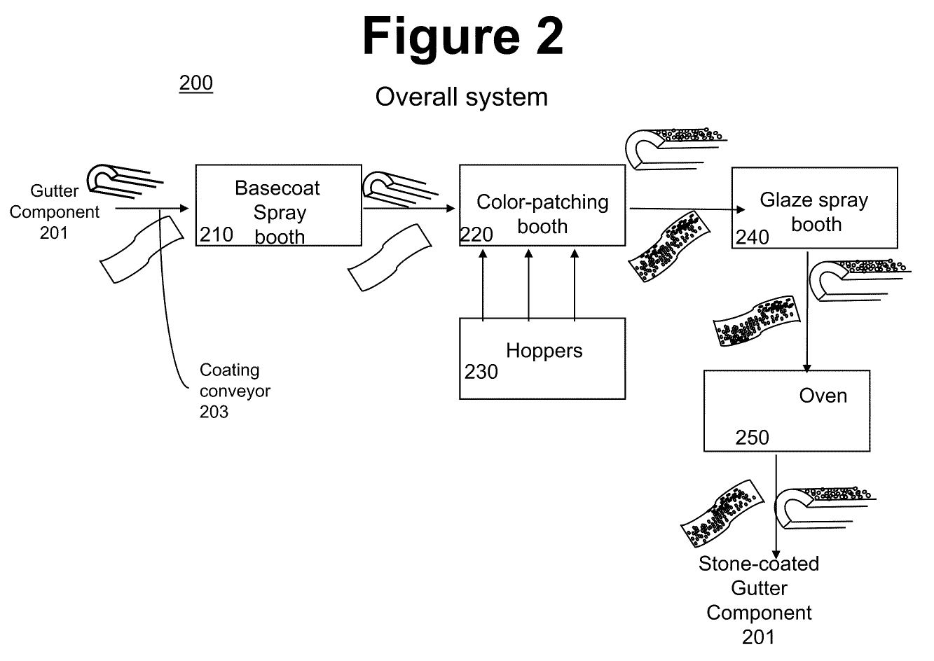

FIG. 2 is a schematic drawing of an overall stone coating application system, according to the aspects of the present invention.

The coating application system 200 is used for stone coating of gutter, vent or other metal components. In the system 200 a gutter component 201 is placed on a coating conveyor 203 and passes through a basecoat spray booth 210, a color-patching boot 220, a glaze spray booth 240, and finally an oven 250. The gutter component 201 is made from metal and is initially bare. After it is coated by the various parts of the system and cured in the oven 240, the gutter component 201 turns into a stone-coated metal gutter component. Hoppers 230 feed the color-patching booth 220 with stone granules that are used for creating shades and shadows or color patches on the gutter component.

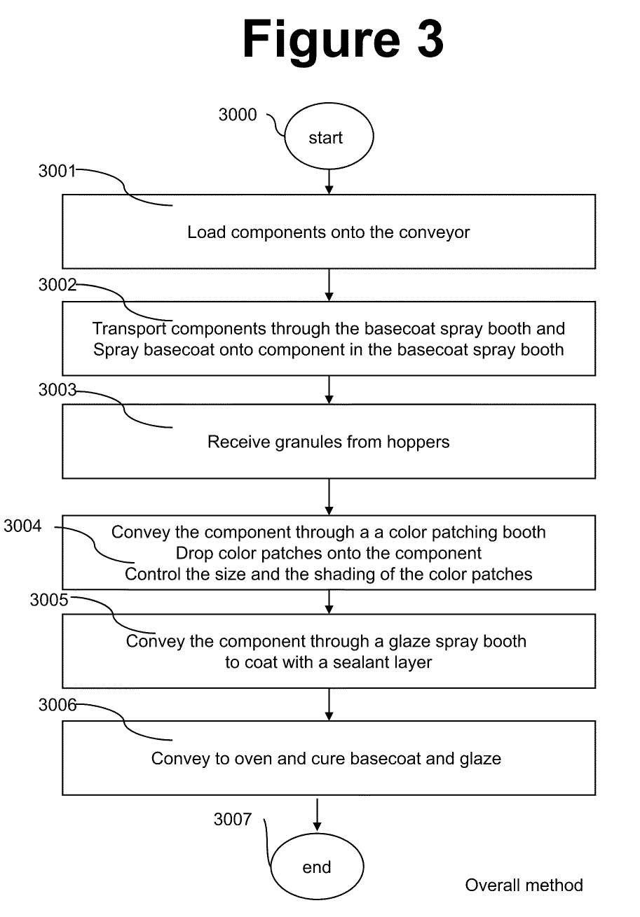

FIG. 3 shows a flowchart of a method of stone coating for gutter components, according to the aspects of the present invention.

The method begins at 3000. At 3001, the gutter components, vent components or other similar components that are to be stone-coated are loaded onto a conveyor. At 3002, the components are transported through basecoat spray booth where a basecoat is sprayed onto the components. At 3003, granules that create the color patches and shading on the components are received from hoppers. At 3004, the components are transported through a color patching booth where color patches are dropped onto the components. Here, the size and shading of the color-patches is controlled by controlling the rollers that drop the color patches onto the components. After 3004, the components are stone-coated. At 3005, the stone-coated components are conveyed through a glaze spray booth where the stone-coated components are coated with a sealant or a glaze. At 3006, the basecoat and the glaze of the components are cured in an oven. At 3007, the method ends.

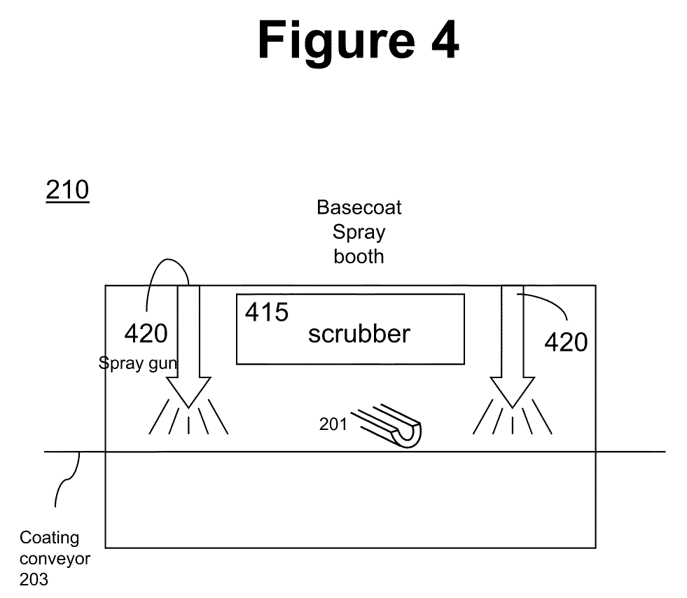

FIG. 4 is a schematic drawing of one exemplary basecoat spray booth for use with the system of FIG. 2, according to the aspects of the present invention.

FIG. 4 shows one exemplary type of the basecoat spray booth 210 of FIG. 2. The basecoat spray booth includes a scrubber 415 that keeps the pressure in the booth negative to prevent over spray of the gutter components and spray guns 420. In one aspect of the present invention, the spray guns 420 turn off if no components are sensed on the coating conveyor 203.

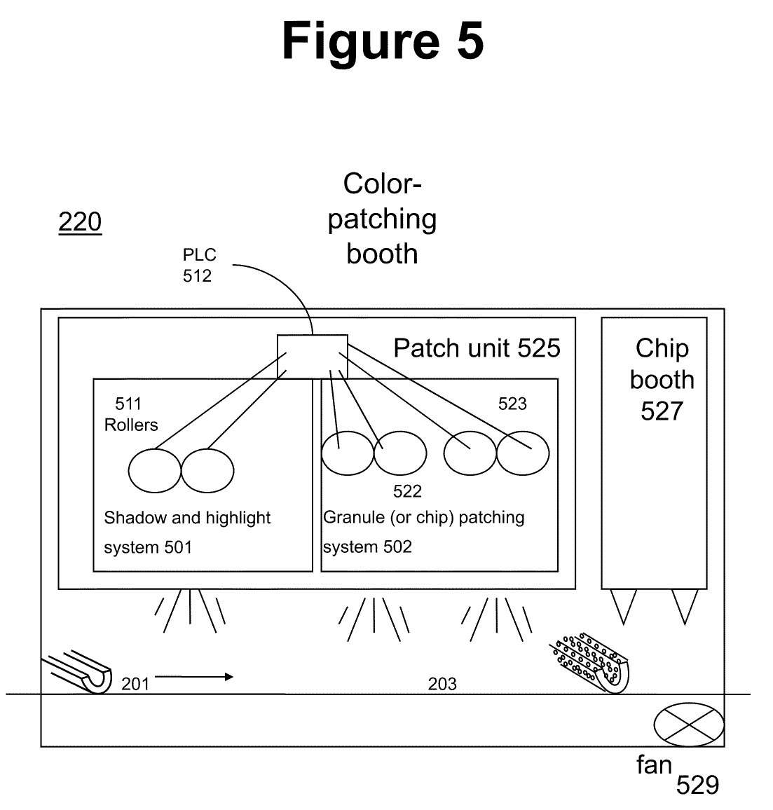

FIG. 5 is a schematic drawing of one exemplary color-patching booth, according to the aspects of the present invention.

FIG. 5 shows one exemplary embodiment of the color-patching booth 220 of FIG. 2. The color-patching booth 220 includes a patch unit 525 and a chip booth 527. The patch unit 525 includes a shadow and highlight system 501 and a granule (or chip) patching system 502. The shadow and highlight system 501 includes a pair of rollers 511 that are driven by servomotors (not shown) that are controlled by a PLC 512. The granule patching system 502 includes two pairs of rollers 522, 523 that are driven by servomotors that are also controlled by the PLC 512. A fan 529 is also included with the color-patching booth 220. A different number of rollers, servomotors and PLCs may be used in other exemplary aspects of the present invention.

The rollers 511 of the shadow and highlight system 501 are grooved and driven to apply narrow bands of stone granules to the components to create the appearance of shadow and highlight. Shadowing may be used to create an appearance of depth when the surface is in fact flat. The grooved rollers 511 of the shadow and highlight system 501 are fed granules from hoppers that are coupled to the color-patching booth. By controlling the speed of rotation of the rollers the amount of stone chips that is dropped on the gutter component is controlled.

The two sets of rollers 522, 523 of the granule patching system 502 are used to apply premixed stone granules from two different hoppers onto the gutter components. Each of the two sets of paired rollers 522 and 523 are used to meter and blend two contrasting mixes of granules and drop them as color patches on the gutter components. By starting and stopping the motors that control the rollers at the right moment as the panel travels under the rollers, the patch size and shading can be controlled.

After the shadowing and color patching is complete, the gutter component passes through the chip booth 527. The chip booth 527 coats the gutter component with its base or background color. All the gaps between the patches and shadows and highlights are filled with a mixed blend of stone granules and then all excess loose granules are blown off by the fan 529.

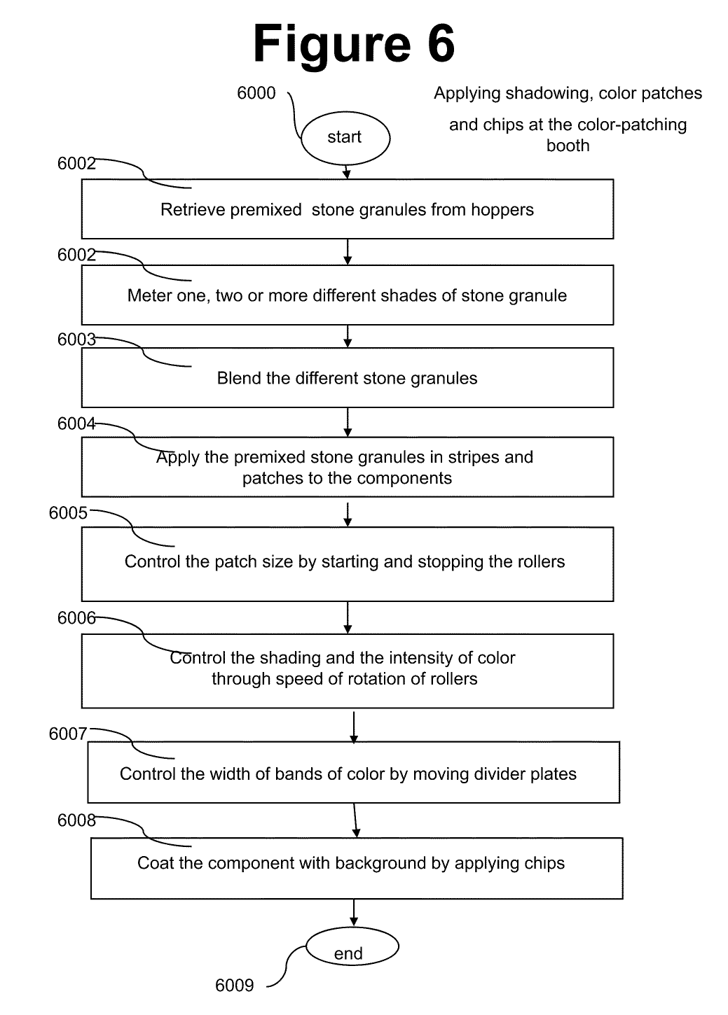

FIG. 6 shows a flowchart of a method of applying color patches and bands at a color-patching booth, according to the aspects of the present invention.

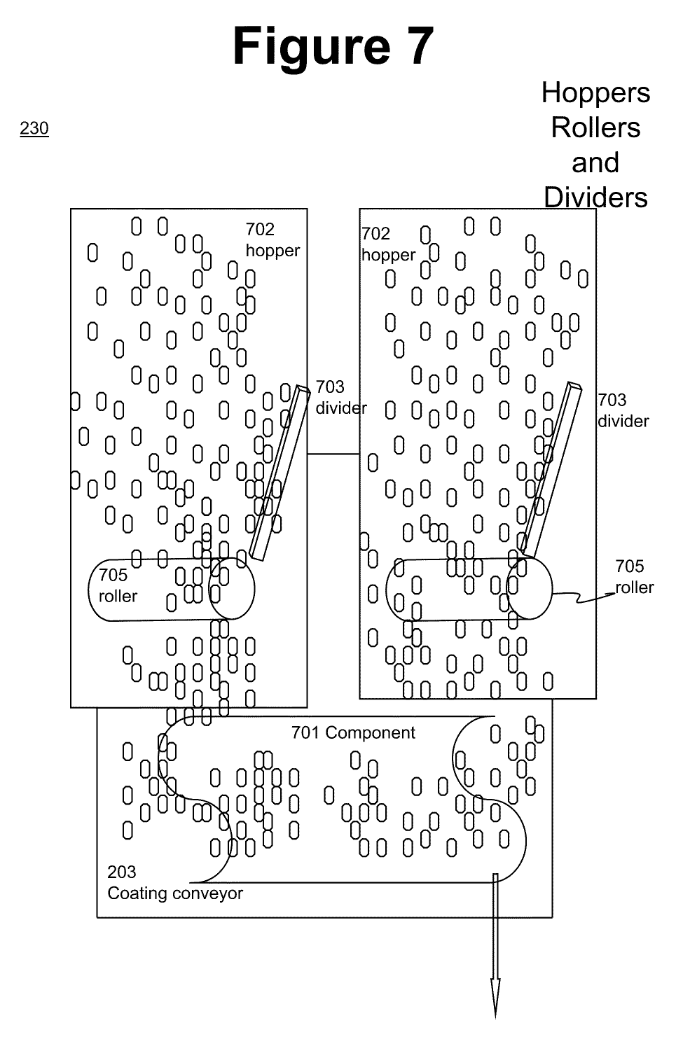

The method begins at 6000. At 6001, premixed stone granules are retrieved or received from hoppers. At 6002, one, two or more shades of stone granules are metered. At 6003, the metered shades are blended. At 6004, the premixed stone granules are applied in stripes and patches to the components. This stage may be carried out by the shadow and highlight system 501 and the granule patching system 502 of the patch unit 525 of FIG. 5. At 6005, the patch size is controlled by controlling the start and stop of the rollers. At 6006, the shading and intensity of color is controlled by controlling and the speed of the rollers. At 6007, the width of bands of color is controlled by moving divider plates on the hoppers that supply the rollers. This stage may be performed by moving dividers 703 of FIG. 7. At 6008, the component is coated with background by applying chips. This stage may be carried out by the chip booth 527 of FIG. 5. At 6009, the method ends.

FIG. 7 is a schematic drawing showing the interaction of hoppers with rollers, dividers and the coating conveyor, according to the aspects of the present invention.

FIG. 7 shows one exemplary arrangement of hoppers 230 of FIG. 2 with respect to the coating conveyor 203 of FIG. 2. Two hoppers 702 are shown that carry the stone granules or chips. Each hopper 702 is fitted with a grooved roller 705 and one or more dividers or divider plates 703. The angle of the dividers 703 causes the chips to bunch up or spread out and may be used to create a heavier band on one edge of the component 701.

As set forth above, the components may be gutter components, metal gutter components, vent components, and similar components suitable for stone coating.

The present invention has been described in relation to particular examples, which are intended to be illustrative rather than restrictive, with the scope and spirit of the invention being indicated by the following claims and their equivalents.

1. A stone-coated gutter component comprising:
a gutter component;
a basecoat covering the gutter component; and
stone granules adhering to the gutter component and coating the gutter component to yield the stone-coated gutter component,
wherein the basecoat causes the stone granules to adhere to the gutter component.

2. The stone-coated gutter component of claim 1,
wherein the gutter component is a gutter cover, and
wherein the gutter component is metal.

3. The stone-coated gutter component of claim 2, wherein the gutter component is made from a metal including aluminum, copper, steel or zinc.

4. The stone-coated gutter component of claim 1, wherein the basecoat includes acrylic water-based glue and is applied at a thickness of 350 micrometers.

5. The stone-coated gutter component of claim 1, wherein the stone granules are grade 14 ceramic coated stone granules.

6. The stone-coated gutter component of claim 1, further comprising:
a sealant applied to the stone-coated gutter component after applying the stone granules.

7. The stone-coated gutter component of claim 6, wherein the sealant is a water-based acrylic adhesive and is applied to achieve a wet thickness of 25 micrometers.

8. The stone-coated gutter component of claim 6,
wherein the stone-coated gutter component is cured in an oven, and
wherein the curing time has a duration of 70 minutes.

9. The stone-coated gutter component of claim 1, further comprising:
a mixed blend of stone chips applied to the stone-coated gutter component to create background color,
wherein excess of the stone chips are blown away from the stone-coated gutter component.

10. A method for stone coating gutter components, the method comprising:
applying a basecoat to a gutter component;
applying stone granules to the gutter component after having applied the basecoat, the stone granules being applied by rollers receiving the stone granules from hoppers, the stone granules being applied in patches or bands;
controlling a size of the patches or bands by controlling a start and stop of the rollers; and
controlling a shading and an intensity of color of the patches or bands by controlling a speed of the rollers,
wherein the rollers are controlled by a programmable logic controller,
wherein the gutter components are made of metal, and
wherein the gutter components include gutter covers.

11. The method of claim 10, wherein the programmable logic controller controls servomotors driving the rollers.

12. The method of claim 10, wherein the rollers are grooved and are used in sets of rollers, each set including a pair of rollers.

13. The method of claim 10, further comprising:
controlling a width of the bands by moving divider plates on the hoppers; and
coating the gutter component with background by applying chips at a chip booth following the applying of stone granules to the gutter component.

14. The method of claim 10, further comprising:
applying a sealant to the gutter component after applying the stone granules; and
curing the gutter component in an oven,
wherein the curing begins at an initial temperature of 60 degrees Centigrade and temperature is gradually raised to 100 degrees Centigrade, and
wherein the curing lasts between 65 to 75 minutes.

15. A device for stone coating gutter components, the device comprising:
sets of rollers for applying stone granules to a gutter component to obtain stone-coated gutter components;
one or more motors for controlling rollers in the sets of rollers; and
one or more programmable logic controllers for controlling the motors,
wherein the motors control a shading of color on the stone-coated gutter component by controlling a speed of rotation of the rollers,
wherein the motors control a size and location of color patches on the stone-coated gutter component by controlling a start and stop of the rotation of the rollers, and
wherein the programmable logic controller is programmed to control the motors.

16. The device of claim 15, further comprising:
a chip booth for applying a mixed blend of stone chips to the stone-coated gutter component to create background color; and
a fan for blowing off excess of the stone chips from the stone-coated gutter component.

17. The device of claim 15, wherein each of the sets of rollers includes a pair of grooved rollers.

18. A system for stone coating gutter components, the system comprising:
a coating conveyor for conveying a gutter component through the system;
a basecoat spray booth for applying a basecoat to the gutter component to obtain a sprayed gutter component; and
a color-patching booth for applying stone chips to the sprayed gutter component to obtain a color-patched gutter component,
wherein the color-patching booth includes sets of rollers being controlled by servomotors,
wherein a start and stop and a speed of rotation of rollers in the sets of rollers is controlled by the servomotors through a programmable logic controller, and
wherein the start and stop of the rollers determines a size of color patches generated by the color-patching booth, and the speed of rotation of rollers determines a shadowing of highlights generated by the color-patching booth.

19. The system of claim 18, further comprising:
a glaze spray booth for applying a sealant to the color-patched gutter component to obtain a sealed gutter component;
an oven for curing the sealed gutter component to obtain a stain-coated gutter component; and
hoppers for feeding the stone chips to the color-patching booth.

20. The system of claim 19, further comprising:
divider planes impacting an amount of stone chips fed by the hoppers.
